(19) United States
(12) Patent Application Publication
(10) Pub. No.: US 2020/0386406 A1
(43) Pub. Date: Dec. 10, 2020

(54) AIRCRAFT ENGINE AND METHOD OF OPERATION THEREOF

(71) Applicant: PRATT & WHITNEY CANADA CORP., Longueuil (CA)

(72) Inventors: Timothy REDFORD, Campbellville (CA); David MENHEERE, Norval (CA); Daniel VAN DEN ENDE, Mississauga (CA); Santo CHIAPPETTA, Georgetown (CA)

(21) Appl. No.: 16/719,341

(22) Filed: Dec. 18, 2019

Related U.S. Application Data
(63) Continuation of application No. 16/433,664, filed on Jun. 6, 2019.

(51) Int. Cl. F23R 3/42; F02C 3/04; F02C 7/36

(52) U.S. Cl. CPC F23R 3/42; F02C 3/04; F05D 2220/323; F05D 2220/36; F02C 7/36

(57) ABSTRACT

The aircraft engine can have a core gas path extending from an intake across a core compressor, and then manifolding to a plurality turbine intake paths, each turbine intake path leading to a respective turbine unit via a respective combustor unit, and gearing drivingly connecting the collective rotary power of the turbine units to at least one power output shaft. During operation, the different core-turbine units can be operated simultaneously and efficiently, or one or more of the core-turbine units can be selectively shut down while the other core-turbine units continue to operate efficiently to lower the power output.

### CROSS-REFERENCE TO RELATED APPLICATIONS

This application claims priority of U.S. application Ser. No. 16/433,664 filed Jun. 6, 2019, the entire contents of which are incorporated by reference herein.

### TECHNICAL FIELD

The application related generally to gas turbine engines and, more particularly, to gas path configurations thereof.

### BACKGROUND OF THE ART

Aircraft turbine engines operate at a variety of design points, including takeoff and cruise, and are also designed in a manner to handle off-design conditions. Some aircraft can have large power differences between operating points, such as between takeoff and cruise for instance, which can pose a challenge when attempting to design an engine which is fuel efficient. Indeed, some aircraft engines are over-designed when viewed from the cruise standpoint, to be capable of handling takeoff power, which can result in operating the engine during cruise in a less than optimal regime from the standpoint of efficiency. It could be easier, based on the power requirements, to use two smaller engines at takeoff power and revert to a single powered engine in cruise. However, such a second engine may add weight, complexity, can reduce the reliability of the overall package, and can introduce subsequent challenges such as cold engine start times and one engine inoperative (OEI) requirements, if one engine is turned off in cruise flight. Accordingly, there remained room for improvement.

### SUMMARY

In one aspect, there is provided a gas turbine engine having a core gas path extending from an intake across a core compressor, and then manifolding to a plurality turbine intake paths, each turbine intake path leading to a respective turbine unit via a respective combustor unit, and gearing drivingly connecting the collective rotary power of the turbine units to at least one power output shaft. The gas turbine engine can be an aircraft engine, for instance.

In another aspect, there is provided a method of operating an aircraft engine, the method comprising: manifolding compressed air outputted by a compressor to a plurality of individual turbine units via respective combustors, including injecting and combusting fuel in the respective combustors to generate hot gas, the turbine units extracting energy from the hot gas in the form of rotation power, the rotation power of said turbine units collectively driving the rotation of at least one shaft.

### DESCRIPTION OF THE DRAWINGS

Reference is now made to the accompanying figures in which:

FIG. 1 is a schematic cross-sectional view of a gas turbine engine;

FIGS. 2A, 2B, 2C and 2D are schematic cross-sectional views of alternate gas turbine engine configurations in accordance with embodiments; and

FIG. 3 is a schematic cross-sectional view of a turboprop gas turbine engine.

### DETAILED DESCRIPTION

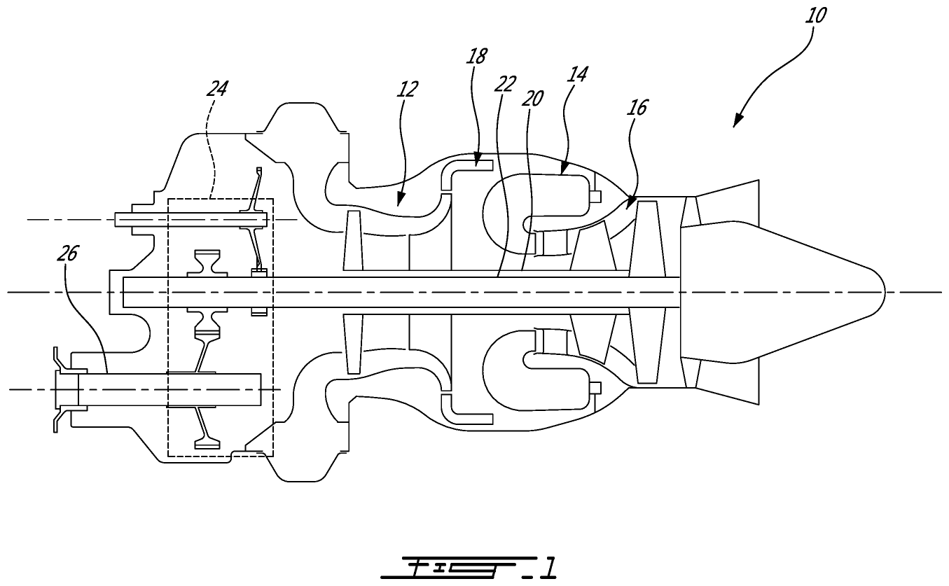

FIG. 1 illustrates an example of a turbine engine. In this example, the turbine engine 10 is a turboshaft engine generally comprising in serial flow communication, a multistage compressor 12 for pressurizing the air, a combustor 14 in which the compressed air is mixed with fuel and ignited for generating an annular stream of hot combustion gases, and a turbine section 16 for extracting energy from the combustion gases. The turbine engine terminates in an exhaust section.

The fluid path extending sequentially across the compressor 12, the combustor 14 and the turbine 16 can be referred to as the core gas path 18. In practice, the combustor 14 can include a plurality of identical, circumferentially interspaced, combustor units. In the embodiment shown in FIG. 1, the turboshaft engine 10 has two compressor and turbine stages, including a high pressure stage associated to a high pressure shaft 20, and a low pressure stage associated to a low pressure shaft 22. The low pressure shaft 22 is used as a power source during use, and the low pressure turbine can thus be referred to as a power turbine.

Turboshaft engines, similarly to turboprop engines, typically have some form of gearing by which the power of the low pressure shaft 22 is transferred to a load. The load can be an external shaft 26 bearing the blades or propeller, or an electric generator for instance. Some turbofan designs can also have some form of gearing via which power is transferred to a shaft bearing a fan, such as an aft fan arrangement for instance. Gearing, which can be referred to as a gearbox 24 for the sake of simplicity, typically reduces the rotation speed to reach an external rotation speed which is better adapted to a rotation speed of the load.

Some applications, such as helicopters to name one example, can have large power differences between Take-Off (TO) and cruise. In some embodiments, a further power requirement can exist, such as a 30 second one-engine inoperable (OEI) power requirement for instance, which can be even higher than the Take-off power requirement. A typical helicopter can require less than 50% power to cruise versus its highest power rating. Since an engine can be significantly more fuel efficient at its design power, designing the engine to the take-off power level, or to the OEI power level, for instance, can result in the engine running in off-design condition for the majority of its mission, leaving a want for better fuel efficiency.

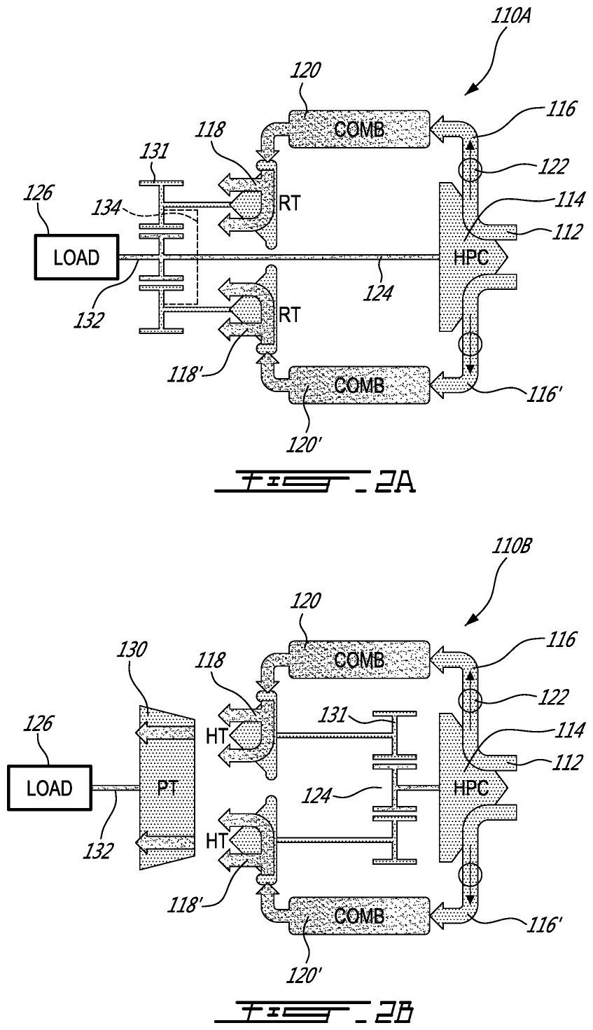

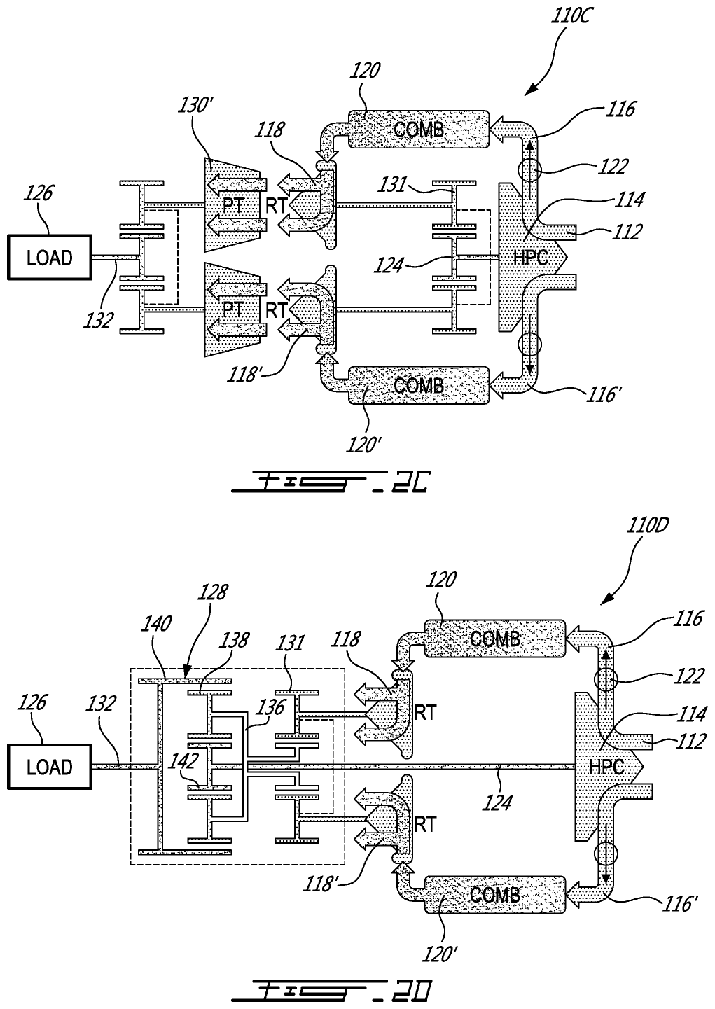

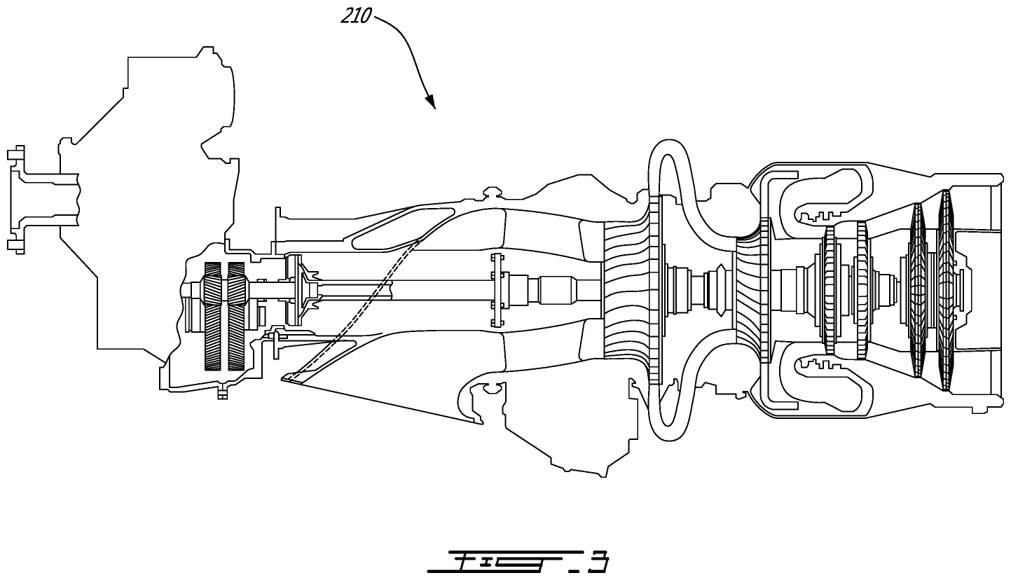

FIG. 2A to 2D show four examples of aircraft engines 110A, 110B, 110C, 110D which have a core gas path 112 extending from an intake across a core compressor 114, and wherein the core gas path 112 then manifolds into a plurality of distinct turbine intake paths 116, 116′. Each turbine intake path 116, 116′ leads to a respective turbine unit 118, 118′ via a dedicated combustor unit 120, 120′. In each one of these examples, the collective rotary power of the turbine units 118, 118′ is used to drive at least one output shaft. The examples of FIG. 2A to FIG. 2D differ in the way that the collective power of the turbine units 118, 118′ is used, and/or by the configuration of optional power turbine(s) downstream of the turbine units 118, 118′. These examples differ in how the compressor 114 is driven and how a load is driven. Before exploring the differences between the example aircraft engine configurations 110A, 110B, 110C, 110D, we will discuss how the turbine units 18, 18′ can be used to generate varying levels of power.

In either one of these examples, at least one of the turbine units 118, 118′ is de-activatable independently of the activation of the others. The turbine units can be identical, or different depending on the application. For instance, a turbine unit 118 can be independently deactivatable via independent control of the fuel supply to the corresponding combustor unit 120. In one embodiment, a valve 122 present in the turbine intake path 116 can be operated to close off the turbine intake path 116, and thus cut the supply of compressed air from the compressor 114. In these examples, gearing interconnects the rotation of the turbine units 118, 118′ to one another. This can be achieved by connecting the turbines 118, 118′ to corresponding planet gears of a gearbox, such as via an epicyclic gear train, for instance. In a context where the rotation of the turbines 118, 118′ are interconnected, the deactivated turbine 118 can continue to rotate, evacuating air or gas from the corresponding turbine intake path 116 and thereafter operating in a low pressure, low aerodynamic loss environment, and staying ready for rapid eventual re-activation. Indeed, by maintaining the rotation of the deactivated turbine 118, a delay associated with accelerating the rotation speed upon re-activating the deactivated turbine 118 can be avoided. Moreover, it may not be required to use a starter, such as an electric starter, on individual ones of the turbine units, as the presence of an electric starter on only one of the turbine units 118, 118′, or on an output shaft, may be sufficient to provide starting rotation to all turbine units, which can lead to significant simplification by comparison with a configuration using a plurality of gas turbine engines or a plurality of gas turbine engine cores (including individual compressors).

The selective de-activation of one, or more, of the turbine units 118, 118′ can be used to achieve different power requirements in a more fuel-efficient manner. For instance, it can be preferred to use all turbine units 118, 118′ simultaneously at a high and fuel efficient power level to produce power during takeoff and/or climbing, and then, when a cruise state of the aircraft is reached, it can be preferred to shut down one, or more of the turbine units (e.g. 118) and continue using the active turbine units (e.g. 118′) at a high and fuel efficient power level, but globally producing a lower power level such as cruise power.

In some embodiments, it can be preferred to allow all of the turbine units 118, 118′ to be selectively de-activatable independently from the activation of the others. Indeed, allowing all turbine units to be selectively de-activatable can allow to perform a rotation/alternation as to which ones of the turbine units are used during cruise, from one flight to another, or even during a flight, which can even out the wear across all turbine and combustor units. The selective activation and deactivation can be controlled by software, for instance, in a manner for the process to be automated.

In the example aircraft engines 110A, 110B, 110C, 110D, the collective power output of the active turbine units 118, 118′ is used to drive the rotation of the compressor 114 directly or ultimately via a compressor shaft 124. In the examples of FIGS. 2A and 2D, the collective power output of the active turbine units 118, 118′ is used to further drive a load 126. In the example configuration of FIG. 2D, the load is driven via a differential 128, whereas in the example of FIG. 2A, the load 126 is driven directly, using a single output shaft as a sun gear connected to the planets 131 of the gearbox, and connecting both the load and the compressor 114. In FIGS. 2B and 2C, one or more power turbines 130, 130′ are used to drive a load 126, and the turbine units 118, 118′, which can be referred to as high pressure turbine units, are used only to drive the compressor 114.

The number of turbine intake paths 116 can vary from one embodiment to another. In some embodiments, it can be preferred to have 4 or 5 gas turbine paths, and to shut down one, or two gas turbine paths when transitioning from takeoff power to cruise power. In other embodiments, the number of gas turbine paths can differ, and some embodiments may have only two gas turbine paths, or more than 5 gas turbine paths. The axes of the turbine units 118, 118′ can be radially spaced apart from the axis of the compressor shaft, and the turbine units 118, 118′ can be circumferentially interspaced from one another around the axis of the compressor shaft.

For instance, in one example having 4 independent combustor-turbine sets, the power of the engine core can be controlled by turning on and off the combustors as follows:

At MTO/OEI power, all the combustors can be fueled and propel their turbines.

At some load part power (e.g. 75%), one combustor can be shut down (fuel and compressor air cutoff) and the remaining 3 can remain at full power.

At lower load part power (e.g. 25%-50%), two combustors can be shut down and the remaining 2 can be at full power.

Indeed, while the engine is in the design phase, the number of combustor-turbine sets can be determined by the requirements of the engine—that is, where the engine design point for optimal efficiency is planned (i.e. MCR/LRC power). For example, if the rated power levels for MTO and MCR are at 100% and 70%, respectively, the engine might be optimally designed with 4 or 5 sets of combustor-turbine sets.

From a performance standpoint, the active combustor-turbine pairs can operate at more of a constant T4 and Q4, at the two design power ratings, which can be designed for peak thermal efficiency. The epicyclic planets, remote from the main axis, can rotate much faster than the compressor and output shaft, which can coincide with the main axis, which can allow the turbines to spin at a very fast speed and improve their efficiency. The differential gear can maintain the compressor running on a smooth running line, whether all the combustors are operating or not. The engine can be designed with the MCR/LRC configuration (1 less combustor) on or just below the surge line and the MTO configuration below this line.

Considering operability, when a combustor-turbine is shut down the compressor airflow feeding it can be closed off via a valve and this can leave the turbine essentially rotating in a vacuum. The continued rotation of this turbine allows the engine to throttle back to high power quickly when compressor flow and fuel are turned back on—that is, inertial acceleration time can be significantly reduced because the epicyclic planets maintain can maintain all turbines spinning at the same speed, regardless of whether a combustor is active or not.

In one possible approach, instead of assigning one combustor-turbine set to be a primary one, active at all time, each of the multiple sets can be activated or deactivated based on utilization in order to manage the durability of the components. For example, if we consider the case where the load power reduced from full to 75% power, each instance when the power is reduced a different combustor-turbine set can be turned off so that over time they all share the same duty cycle, the same durability. Additionally, if the engine is operating at the same output power for a long period of time (LRC), the offline combustor-turbine could be brought back online and a different pair could be taken off-line. The selection of which combustor-turbine to turn off can be controlled by software.

Referring to FIG. 2A, the example aircraft engine 110A has planet gears individually connected to respective turbine units, which can be achieved by casting the gears as part of the respective turbine shafts for instance or using other processes. A single output shaft acts both as a power shaft and a compressor shaft 124, and incorporates a sun gear engaged with the planet gears. The planet gears can be received in a carrier 134 which is in a fixed, non-rotary relationship with a casing of the engine.

In FIG. 2B, the example aircraft engine 110B has planet gears 131 individually engaged with the compressor shaft 124 sun gear in a manner that the planet gears 131 collectively drive the rotation of the compressor shaft 124 and the rotation of any deactivated turbine. Downstream of the turbine units, the fluid output of the turbine units can recombine into an annular flow, and the annular flow can be used to drive a power turbine. The power turbine can have a power shaft 132 connected to drive a load 126 directly, or via a gearbox for instance.

In FIG. 2C, the example aircraft engine 110C has planet gears 131 engaged with the compressor shaft similar to FIG. 2B. However, a plurality of distinct power turbine units 130′ are used, each one receiving the fluid output of a respective turbine unit 118 (which can be referred to here as high pressure turbine unit 118). The power turbine units 130′ are connected to planet gears and drive a power shaft 132 similarly as to how the high pressure turbine units 118 drive the compressor shaft 124.

In FIG. 2D, the turbine units 118, 118′ are used to collectively drive both the rotation of the compressor 114 and the load 126. However, instead of doing this directly such as in FIG. 2A, this is done here via a differential which can accommodate variations of a rotation speed ratio between the compressor shaft 124 and the power shaft 132. In this specific embodiment, the differential is constructed as follows: a set of first planet gears 131 forming part of a first epicyclic gear train are associated to the turbine units 118, 118′. This set of first planet gears 131 do not rotate around the axis of the compressor shaft 124, but transfers its power, via a carrier 136, to a second set of planet gears 138, also part of an epicyclic gear train, which both rotate around their individual axes and collectively rotate around the axis of the compressor shaft 124. This second set of planet gears can transfer its power both to the power shaft 132 and to the compressor shaft 124 via a corresponding one of a ring gear 140 and of a sun gear 142. In this example, the sun gear 142 is associated to the compressor shaft 124 and the ring gear 140 is associated to the power shaft 132. The differential can allow the compressor to spin at variable relative rotation speeds, which may allow to achieve better overall engine performance in some embodiments.

More specifically, in one embodiment having 4 turbines, the differential gear box can split the total turbine torque (here, from the carrier gear) at a constant ratio between the output shaft (ring gear) and the compressor (sun gear). When the load power reduces (e.g. transitioning from MTO to MCR), the torque on the two output shafts (sun and carrier) is reduced as well. As the power continues to reduce, when the combined power of the turbines through the carrier reaches ˜75% (this would ideally be at a design rating), one if the 4 combustor-turbine sets is turned off and the power output of the remaining 3 increases to compensate—the total torque on the remaining three (3) turbines, each at higher turbine power, is the same total torque on all 4 turbines at lower power a moment before. The benefits of this will be that the turbine will run closer to the high power conditions again—higher speed, flow and temperature—for improved operating efficiency. The torque to the compressor is also maintained when the combustor is taken offline; and the compressor speed, flow and PR will increase towards the SL to maintain the thermal efficiency.

During operation of the aircraft engine, air outputted by the compressor can be manifolded to a plurality of individual turbine units via respective combustors in which fuel can be injected and combusted to generate hot gas. The turbine units can extract energy from the hot gas in the form of rotation power, and the rotation power of the turbine units can collectively drive the rotation of at least one shaft. To transition to a lower power output, one or more of the turbine units can be deactivated while maintaining the activation of other ones of the turbine units. This can be done by interrupting a supply of fuel to the respective combustor and closing off a path of the compressed air leading to the respective turbine unit. This can be done while the power of the other turbine units continue to drive the deactivated turbine unit(s) into a rotary state.

Accordingly, at the engine design stage, it is possible to choose the size and the number of combustor-turbine units, as well as the number which are to be deactivated to transition from a common high power mode to a common lower power mode, in a manner to target fuel efficiency at both power levels.

In some embodiments, it can be desired for the rotation speed of the power turbine's shaft not to vary too much between the different power levels. The rotation speed of the power shaft at the takeoff power level can be less than 140% of the rotation speed of the power shaft at the cruise power level, for instance, possibly less than 130% (e.g. for turboprop), possibly less than 110% (e.g. for turboshaft), and even possibly less than 105%. This while the amount of power generated at the cruise power level can be less than ¾ of the amount of power generated at the takeoff power level, possibly less than 213^{rd}, and even possibly less than ½.

In some embodiments, a boost compressor can be used upstream of the compressor 114. The effect of the boost pressure on the engine can have the effect of increasing the power output in direct relation to the pressure ratio. Accordingly, doubling the power output of the engine can be accomplished by doubling the boost pressure entering the core compressor. A configuration where the power shaft is deposed and separate from the core shaft, with the boost compressor isolated, can avoid scenarios where a shaft has to extend within another shaft, which are less desired because of potential dynamic unstability. If a power-turbine load shaft is introduced, an output shaft from a differential can be connected to such a boost compressor, for instance. In one embodiment, the fluid output of the turbine units can be reversed and configured in a manner to transfer heat into the turbine intake paths 116, 116′.

The embodiments described in this document provide non-limiting examples of possible implementations of the present technology. Upon review of the present disclosure, a person of ordinary skill in the art will recognize that changes may be made to the embodiments described herein without departing from the scope of the present technology. In one embodiment shown, the power turbine is used to drive the load, and is distinct from the core turbines. In alternate embodiments, one or more power turbine can be drivingly connected to the core turbines, or positioned between the combustor and the core turbines, and a different arrangement or core turbine and/or power turbine can be used to drive the core compressor, and/or load. In one embodiment described above, the valves can be configured in a manner to either selectively fully open or fully close the corresponding turbine intake path. In an alternate embodiment, the valves can be configured to tune the size of the opening to one or more intermediate degrees of opening. In the embodiment shown in FIGS. 2A to 2D, a single centrifugal compressor is illustrated. It will be understood that in alternate embodiments, the compressor can be axial instead of centrifugal, and can alternately include multiple stages, axial and/or centrifugal. The configuration of the gearing can change significantly from one embodiment to another, and can vary depending on the number of turbine-combustor units, desired power output, and general engine configuration among other factors. In one embodiment, the turbine units can be connected to a shaft using a spur gear, for instance. The embodiments described herein can be applied to different engine architectures. FIG. 3, for instance, illustrates a turboprop 210 adapted to drive a propeller, and which may be modified based on the teachings presented above in a manner to incorporate a selectively useable auxiliary components. In one embodiment, the gas turbine engine can be an auxiliary power unit (APU), and the APU can have a generator and/or a load compressor mounted to at least one power output shaft. Yet further modifications could be implemented by a person of ordinary skill in the art in view of the present disclosure, which modifications would be within the scope of the present technology.

1. A gas turbine engine having a core gas path extending from an intake across a core compressor, and then fluidly branching to a plurality of turbine intake paths, each turbine intake path leading to a respective turbine unit via a respective combustor unit, and gearing drivingly connecting the turbine units to at least one power output shaft.

2. The gas turbine engine of claim 1 further comprising at least one valve operable to open and close a respective turbine intake path.

3. The gas turbine engine of claim 1 wherein the combustor units are all independently operable, wherein said at least one valve includes a plurality of said valves.

4. The gas turbine engine of claim 1 wherein the at least one power output shaft includes a shaft drivingly connected to the compressor.

5. The gas turbine engine of claim 4 wherein the at least one power output shaft includes only the shaft drivingly connected to the compressor, the shaft further connected to a load.

6. The gas turbine engine of claim 1 wherein the at least one power output shaft includes a power shaft drivingly connected to a load.

7. The gas turbine engine of claim 6 wherein the at least one power output shaft further includes a compressor shaft drivingly connected to the compressor.

8. The gas turbine engine of claim 7 wherein the gearing includes a differential between the collective power input of the turbine units and the power outputs of the power shaft and of the compressor shaft.

9. The gas turbine engine of claim 8 wherein the gearing includes a plurality of first planetary gears each driven by a corresponding turbine unit, the first planetary gears collectively driving the rotation of a carrier bearing a plurality of second planetary gears, the second planetary gears differentially driving a power shaft and a compressor shaft, the power shaft driving a load and the compressor shaft driving the compressor.

10. The gas turbine engine of claim 1 wherein the gearing includes a plurality of planetary gears each driven by a corresponding turbine unit, the plurality of planetary gears collectively driving at least one other gear.

11. The gas turbine engine of claim 1 comprising 4 or 5 of said turbine intake paths, the corresponding turbines being radially spaced apart from, and circumferentially spaced apart from one another around, an axis of said power output shaft.

12. The gas turbine engine of claim 1 wherein the turbine units are high pressure turbine units, wherein a fluid output of each high pressure turbine unit is connected to a fluid input of a respective power turbine unit, further comprising power gearing drivingly connecting the collective rotary power of the power turbine units to a power shaft, the power shaft being connected to a load.

13. The gas turbine engine of claim 1 wherein the a fluid output of each turbine unit recombine into a fluid input of a power turbine unit, said power turbine unit drivingly connected to a load.

14. The gas turbine engine of claim 1 wherein the aircraft engine is a turboshaft engine, further comprising helicopter blades mounted to one of said at least one power output shafts.

15. The gas turbine engine of claim 1 wherein the aircraft engine is a turboprop engine, further comprising a propeller mounted to one of said at least one power output shafts.

16. A method of operating an aircraft engine, the method comprising: manifolding compressed air outputted by a compressor to a plurality of individual turbine units via respective combustors, including injecting and combusting fuel in the respective combustors to generate hot gas, the turbine units extracting energy from the hot gas in the form of rotation power, the rotation power of said turbine units collectively driving the rotation of at least one shaft.

17. The method of claim 16 further comprising deactivating one or more of said turbine units while maintaining the activation of other ones of the turbine units, said deactivating including interrupting a supply of fuel to the respective combustor and closing off a path of said compressed air leading to the respective turbine unit, while maintaining the respective turbine unit in a rotary state using the rotation power of the other turbine units.

18. The method of claim 17 further comprising reactivating said one or more turbine units and deactivating other another one or more of said turbine units.

19. The method of claim 17 wherein said deactivating includes decreasing a power output of the aircraft engine from a takeoff power level to a cruise power level.

20. The method of claim 19 wherein said decreasing a power output of the aircraft engine from a takeoff power level to a cruise power level, includes decreasing a power output of a power shaft, wherein a rotation speed of the power shaft at the takeoff power level is less than 120% of a rotation speed of the power shaft at the cruise power level.
